(19) United States
(12) Patent Application Publication
(10) Pub. No.: US 2007/0133022 A1
(43) Pub. Date: Jun. 14, 2007

(54) Image producing method and apparatus

(75) Inventor: Masayuki Takahira, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/585,074

(22) Filed: Oct. 24, 2006

(30) Foreign Application Priority Data
Oct. 24, 2005 (JP) 2005-308541

(51) Int. Cl. H04N 1/60

(52) U.S. Cl. 358/1.9; 358/448

(57) ABSTRACT

The image producing method and apparatus obtain an input image that has a region covering all of the different output images and has a resolution corresponding to one output image of the different output images whose resolution is highest, subject the input image to at least one color conversion process, or a first scaling in accordance with the one output image whose resolution is highest and the at least one color conversion process to produce an intermediate image and subject the intermediate image to at least one of cropping appropriate to each output image, a second scaling based on a difference in resolution between the intermediate image and each output image, and color conversion into a color space of each output image to thereby produce the different output images.

### BACKGROUND OF THE INVENTION

The present invention relates to the technical field of image production in which individually different images are produced from an original. More specifically, the invention relates to an image producing method and an image producing apparatus that are capable of producing individually different images from an image obtained by one original reading operation.

A digital photoprinter has been recently put to commercial use. In the digital photoprinter, an image recorded on a film is photoelectrically read, converted to digital signals and subjected to various image processing operations to produce image data for recording purposes; a light-sensitive material (photographic paper) is exposed to recording light modulated in accordance with the image data to obtain a print, which is then output.

In a scanner of the digital photoprinter, reading light is made incident on an image shot on a film and light having transmitted through the film is photoelectrically read (hereinafter this image reading operation is referred to as “scanning”). Then, an image processor subjects the image (image data) obtained by scanning to various corrections such as gradation correction, color/density correction, saturation correction and sharpening, and subsequently to color conversion (color space conversion) to obtain an output image for image recording (exposure) with a printer. The output image is hereinafter referred to as the “print image”.

In the printer, for example, a light-sensitive material (photographic paper) is two-dimensionally scanned by exposure to light beams modulated in accordance to the print image to record a latent image, and the exposed light-sensitive material is subjected to a predetermined development process and dried to obtain a (finished photographic) print, which is then output.

The digital photoprinter as described above deals with images as digital data, so not only prints but also a recording medium such as a CD-R in which converted images are recorded as output images of a versatile format such as s-RGB or JPEG (hereinafter the output images are referred to as the “digitized images”) can be provided to a customer or the like.

It is also possible to output the images to various printers including not only a constantly connected printer but also a printer that is lower in image quality but is higher in yield and a printer that is lower in yield but is capable of reproducing an extremely high quality image.

### SUMMARY OF THE INVENTION

As mentioned above, the digital photoprinter can produce different types of output images through image processing. Further, the image processing is capable of producing from a single original output images different from each other, for example, the above-mentioned print image and digitized image, print images corresponding to prints different in size (or resolution), print images having differently cropped regions, and print images for outputting to different printers.

However, in the case where different images are to be produced from an original, it is necessary to perform scanning for each output image and image processing for each image, which may lead to redundant processing.

More specifically, in order to produce the print image and the digitized image, it is necessary to perform on an original two scanning operations including one for obtaining the print image and the other for obtaining the digitized image, and to subject the images obtained by the scanning operations to scaling for output size matching, input color conversion for image correction, setup (gradation correction, color/density correction, saturation correction), output color conversion appropriate to the destination and sharpening (see FIGS. 3A and 3B).

Therefore, the processing including scanning of original becomes redundant and two or more types of images cannot be processed rapidly.

The present invention has been made in order to solve the conventional problems described above and an object of the present invention is to provide an image producing method with which individually different output images (output image data) appropriate to destinations of the images can be rapidly produced from an original through integrated processing without the necessity of more than one image reading (scanning) operation for the individual output images.

Another object of the present invention is to provide an image producing apparatus for implementing the image producing method.

In order to achieve the above-mentioned objects, the present invention provides an image producing method for producing different output images from an input image having been obtained, comprising the steps of:

obtaining the input image that has a region covering all of the different output images and has a resolution corresponding to one output image of the different output images whose resolution is highest;

subjecting the obtained input image to at least one color conversion process, or a first scaling in accordance with the one output image whose resolution is highest and the at least one color conversion process to produce an intermediate image; and

subjecting the intermediate image to at least one of cropping appropriate to each output image, a second scaling based on a difference in resolution between the intermediate image and each output image, and color conversion into a color space of each output image to thereby produce the different output images.

The present invention also provides an image producing apparatus, comprising:

a scanner for photoelectrically reading an image from an original; and

an image processor for processing the image read with the scanner to obtain different output images,

wherein, when the different output images are produced, the scanner reads a region of the original covering all of the different output images in a resolution corresponding to one output image of the different output images whose resolution is highest, and

wherein the image processor subjects the image read with the scanner to at least one color conversion process, or a first scaling in accordance with the one output image whose resolution is highest and the at least one color conversion process to produce an intermediate image, which is then subjected to at least one of cropping appropriate to an output region of each output image, a second scaling based on a difference in resolution between the intermediate image and each output image, and color conversion into a color space of each output image to thereby produce the different output images.

In the image producing method and apparatus of the present invention, the input image is preferably obtained by photoelectrically reading an original, and a minimum region of the original covering all of the different output images is preferably photoelectrically read in a resolution of the one output images whose resolution is highest.

The intermediate image is preferably an image whose color space is identical to that of a first output image whose color space is largest or for which highest image quality is required. It is preferred that the input image be converted to a first image having a specified color space, that the first image be then subjected to image processing that has no input-output dependence to obtain a second image, and that the second image obtained by the image processing be used to produce the intermediate image. The intermediate image is preferably an image obtained by performing a first sharpening in accordance with a second output image whose noise is most readily noticeable. When a third output image that does not conform to the first sharpening the intermediate image has undergone is to be produced, a second sharpening is preferably performed in accordance with the third output image when the third output image is produced from the intermediate image.

When the second scaling is performed on the intermediate image to produce a fourth output image, the second scaling is preferably followed by the second sharpening for compensating for degradation in image sharpness caused by the second scaling. When the intermediate image is an image obtained by performing the first sharpening in accordance with the second output image whose noise is most readily noticeable, the second sharpening for compensating for the degradation in the image sharpness caused by the second scaling and a third sharpening corresponding to one of other output images than the second output image are preferably performed in combination to thereby produce the one of the other output images.

According to the present invention having configured as described above, when individually different images are produced from an original or a piece of image data, one image reading (scanning) operation suffices to obtain an input image and the processing that can be standardized among the respective output images can be performed on the input image, which may result in shortened processing time and reduced hardware cost.

There is no need to carry out more than one image reading operation, so differences in images due to variations in the image reading operation to produce the images can be also reduced.

### BRIEF DESCRIPTION OF THE DRAWINGS

In the accompanying drawings:

FIG. 1 is a block diagram conceptually showing an image producing apparatus according to an embodiment of the present invention;

FIGS. 2A to 2B each are a flow chart illustrating an image producing method according to an embodiment of the present invention; and

FIGS. 3A to 3B each are a flow chart illustrating a conventional method for producing different images.

### DETAILED DESCRIPTION OF THE INVENTION

The image producing method and apparatus of the present invention will be described below in detail with reference to preferred embodiments shown in the accompanying drawings.

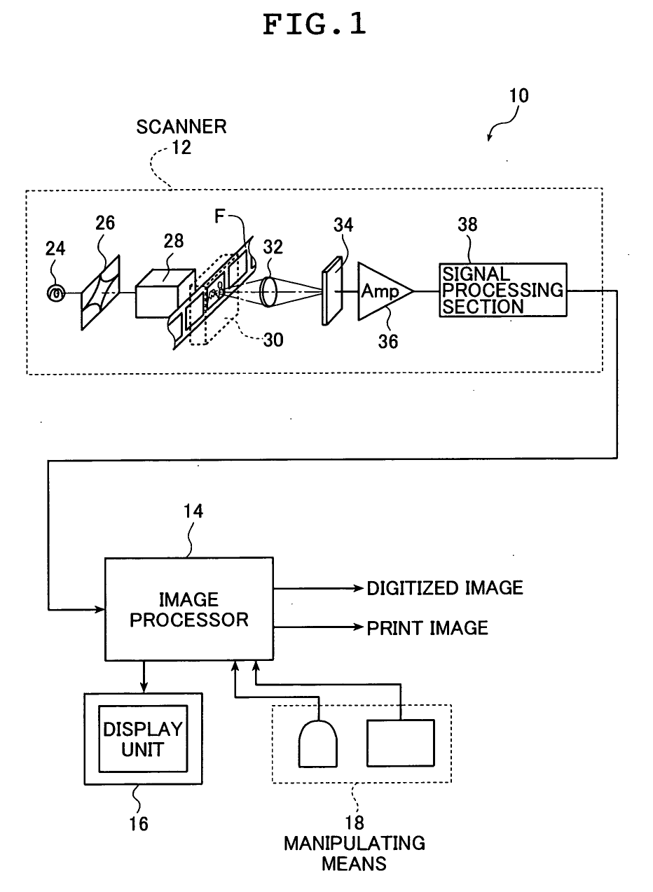

FIG. 1 is a block diagram conceptually showing an embodiment of the image producing apparatus of the present invention that implements the image producing method of the present invention.

An image producing apparatus 10 reads an image shot on a film F and subjects the read image to image processing to produce an output image for preparing a print with a printer (hereinafter referred to as a “print image”) and an output image for storing (writing) on a storage medium such as a CD-R (hereinafter referred to as a “digitized image”). The image producing apparatus 10 basically includes a scanner 12 and an image processor 14.

Connected to the image processor 14 are a display unit 16 and manipulating means 18 including a mouse and a keyboard. The image producing apparatus 10 uses a GUI (Graphical User Interface) that relies on the display on the display unit 16 with the manipulating means 18 thereby selecting or inputting specific commands for various operations.

The scanner 12 includes a light source 24, a variable diaphragm 26, a diffuser box 28, a (film) carrier 30, an imaging optical system 32, a CCD sensor 34, an amplifier 36 and a signal processing section 38.

The scanner 12 is a known device for reading a transparent original in which images shot on the (photographic) film F are photoelectrically read (hereinafter the image reading operation is referred to as “scanning”). Reading light emitted from the light source 24 is adjusted in light quantity with the variable diaphragm 26, diffused in the diffuser box 28 so that the reading light becomes uniform across the plane of the film F and is incident on the film F set at a specified reading position by means of the carrier 30.

The carrier 30 is used to move the film F in the longitudinal direction to sequentially transport each frame of the film F to the specified reading position.

The reading light having passed through the film F, in other words, projected light bearing the image recorded on the film F is imaged on the CDD sensor 34 through the imaging optical system 32. The image shot on the film F is photoelectrically read through photoelectrical reading of the reading light.

The CCD sensor 34 may be an area CCD sensor or a line CCD sensor. In other words, the film F (original) may be scanned in the image producing apparatus 10 of the invention by single scanning in which the film is intermittently moved to sequentially transport each frame to the reading position to read the entire surface of the frame at a time with the area CCD sensor, or by continuous scanning in which the film is continuously transported to continuously read slit-like regions with the line CCD sensor.

The reading resolution to be described later may be changed by any known method appropriate for the scanning method (reading method).

Output signals (reading results) from the CCD sensor 34 are amplified in the amplifier 36 and sent to the signal processing section 38.

The signal processing section 38 subjects the signals sent from the amplifier 36 to A/D conversion to obtain digital signals, which are then subjected to logarithmic conversion to obtain an input image ((density) data of the input image). The input image is then sent to the image processor 14.

Prior to the logarithmic conversion, the digital signals obtained by the A/D conversion may be subjected to signal corrections including shading correction, dark current correction and defective pixel correction. The logarithmic conversion and the optional signal corrections such as the shading correction, dark current correction and defective pixel correction may be performed in the image processor 14 before scaling and its subsequent processing to be described later are performed.

The image processor 14 subjects the image data supplied from the scanner 12 to the scaling, color conversion, setup (image processing), sharpening, cropping and other processing to produce a print image (output image for preparing a print with a printer) and a digitized image (output image for storing on a storage medium such as a CD-R) and output the produced print image and digitized image.

The image processor 14 is configured with, for example, a computer or a workstation. As mentioned above, the display unit 16 and the manipulating means 18 are connected to the image processor 14.

There is no particular limitation on the printer for outputting the print images produced in the present invention, in other words, on the printer appropriate to the output images obtained in the present invention, and output images adapted to use in various known printers such as an inkjet printer, an electrophotographic printer, a thermal printer, and the above-mentioned digital photoprinter in which a light-sensitive material (photographic paper) is exposed to recording light modulated in accordance with a print image and the exposed light-sensitive material is subjected to a specified wet development process, can be produced.

Output images for use in two or more types of printers as in the case of using a digital photoprinter and an inkjet printer may be produced. Alternatively, output images for use in printers of a single type but different models such as digital photoprinters of different models or different performance capabilities, or output images for use in printers of different models and types may be produced.

In the illustrated embodiment, the print image is for example an image for use in a digital photoprinter.

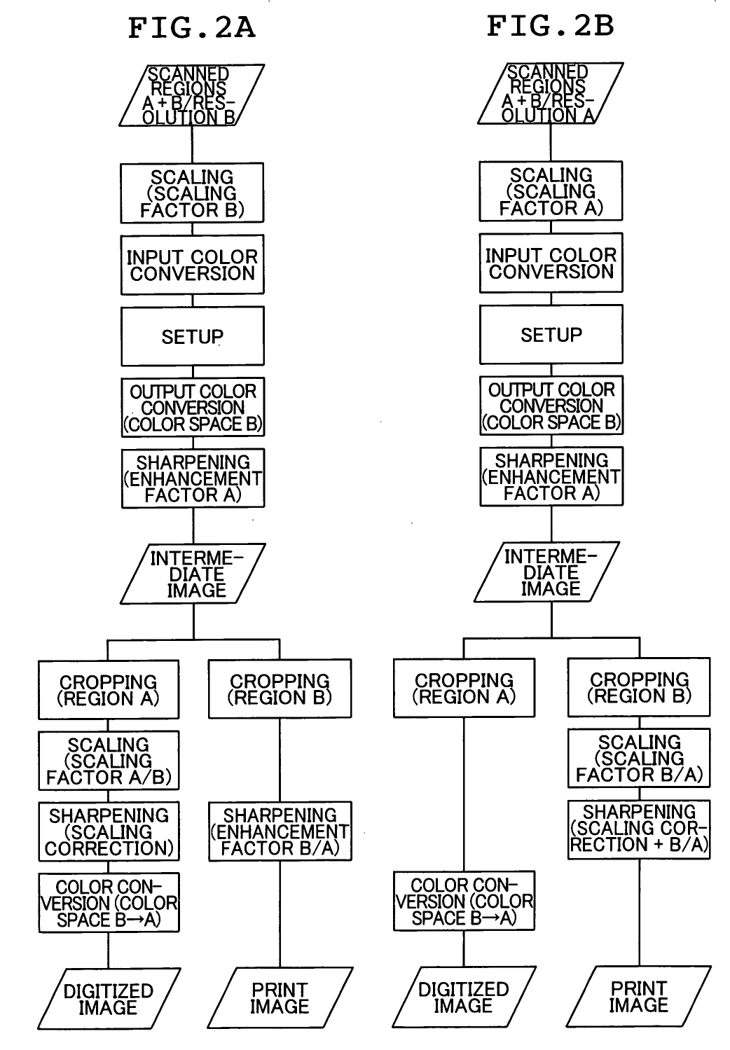

The image processor 14 and the image producing method of the present invention will be described below in further detail by illustrating the operation of the image producing apparatus 10 with reference to flow charts shown in FIGS. 2A and 2B.

In the following description, the case where, when a print image and a digitized image (in total two images) are produced and output as output images, the print image has a higher resolution and a larger color space than the digitized image is taken as an example (see FIG. 2A). In other words, the resolution of the print image is the highest and the color space of the digitized image is the largest, and the resolution of the digitized image is the lowest and the color space of the print image is the smallest.

In FIGS. 2A and 2B, for the sake of convenience, processing parameters related to the digitized image, and those related to the print image are denoted by A and B, respectively. Therefore, the resolution level and the dimension of the color space in this embodiment are correspondingly represented by the relation: A (digitized image)<B (print image).

First, the scanner 12 is used to scan the minimum region of the image in one frame of the film F that covers the regions to be reproduced in the digitized image and print image, in the resolution corresponding to the output image whose resolution is the highest in the output images. In other words, in this embodiment, the minimum region covering all the regions to be reproduced in the digitized image and print image (i.e., regions A+B) are scanned in the resolution corresponding to the print image (i.e., resolution B).

As mentioned above, in the scanner 12, output signals from the CCD sensor 34 are amplified in the amplifier 36 and subjected to A/D conversion and logarithmic conversion in the signal processing section 38 before being supplied to the image processor 14 as an input image.

In the present invention, image reading with the scanner 12 as described above is not the sole method for obtaining the input image, and various methods can be used as long as an input image that has a region covering all output images and has a resolution corresponding to an image whose resolution is the highest in the output images can be obtained.

For example, an input image that has a region covering all the output images and has a higher resolution than the highest resolution in the output images may be acquired by obtaining an image (image data) shot with a digital camera or the like and subjecting the obtained image to scaling or cropping.

First of all, the image processor 14 subjects the supplied input image to a first scaling (electronic magnification) so that the input image can have the same resolution as the output image whose resolution is the highest. As mentioned above, in this embodiment, the print image has a higher resolution than the digitized image, so the input image is subjected to the first scaling by a scaling factor to obtain the resolution of the print image (i.e., scaling factor B). The resolution (image size) after the first scaling has been performed is the resolution of an intermediate image to be described later.

As mentioned above, the film F is scanned with the scanner 12 according to the highest resolution in the output images (print image in this embodiment). However, in the commonly used scanner 12, reading resolution is adjusted stepwise and an input image having quite the same resolution as a target resolution can be hardly obtained. Therefore, in the present invention, the input image is subjected to the first scaling to obtain an image having the same resolution as the output image whose resolution is the highest. The first scaling is not necessary in the case where the input image obtained by scanning is an image that has the same resolution as the output image whose resolution is the highest. The first scaling may be performed by any known method.

The input image having undergone the first scaling is then subjected to input color conversion to obtain an image having a specified color space in the image processor 14.

The input image may be of any of various formats depending on the image supply source. The output image may also be of any of various formats depending on its destination and use. Actually, it is extremely difficult to prepare an image processing system compatible with all the images of these various formats. Therefore, in the illustrated image processor 14, the input image is subjected to the input color conversion to obtain an image having a specified color space for performing common processing operations that have no input-output dependence.

There is no particular limitation on the color space obtained by the input color conversion, and a color space particularly set for the image processor 14 or a normalized color space such as s-RGB may be used. The method of color conversion is also not particularly limited and any known method such as a method using a 3D-LUT (look-up table) may be applied.

Then, the image having undergone the input color conversion is set up.

In the illustrated case, setup (setup processing) is processing for correcting color variations of an original image, and gradation/dynamic range correction, color/density correction and saturation correction correspond to image processing to be performed in the setup. Although not shown, the present invention may perform various image processing operations including processing for incorporating user preferences in terms of the tint and brightness, red-eye correction and corrections to image defects such as a correction for removing flaws, before or after the setup and/or in parallel with the setup. The various processing operations may be performed by any known method.

In the present invention, shortened processing time and simplified processing are possible by standardizing the input color conversion, setup and optionally correction for incorporating user preferences into image and corrections to image defects among all the images.

Then, output color conversion is performed to obtain an image having the same color space as the output image whose color space is the largest (an image having the same color space as the output image whose color space has the largest color reproduction range). As mentioned above, in this embodiment, the image is converted to one having the color space of the print image (i.e., color space B) through the output color conversion, since the print image has a larger color space than the digitized image (A<B).

As will be described later, in the present invention, the input image is processed to produce an intermediate image that is common to all the output images. The respective output images are produced from the intermediate image. Such output color conversion is performed to obtain the intermediate image that has the same color space as the output image whose color space is the largest, whereby lack of information due to various processing operations to be subsequently performed can be prevented to obtain high-quality images as the output images.

The output color conversion is not limited to one in which the input image is converted to have the same color space as the output image whose color space is the largest. In another preferred embodiment, an image may be converted to have the same color space as the output image for which the highest image quality is required (destination holding the most important colors) and the resulting image may be treated as the intermediate image. More specifically, even in the illustrated case where, when a print image and a digitized image are output, higher image quality is required for the print image than the digitized image, although the digitized image has a larger color space than the print image, the intermediate image may have the same color space as that of the print image.

Take, for example, the case where the digitized image has s-RGB color space. The s-RGB color space is large in the light region (region with high lightness) but is narrow in the dark region (region with low lightness). Therefore, if the s-RGB image is converted to have a different color space, colors to which weight is given in a print (hard copy) as exemplified by bright green in a forest and emerald blue in a sea cannot be properly reproduced.

In order to obviate such an inconvenience, in the case where higher image quality is required for one of output images, an image may be converted through the output color conversion irrespective of the dimension of the color space so as to have the same color space as the output image for which the highest image quality is required such that the resulting image having this color space can be treated as the intermediate image.

Whether the intermediate image having undergone the output color conversion is to have the same color space as the output image whose color space is the largest or the same color space as the output image for which the highest image quality is required is determined as appropriate according to the use of the output image or the required image quality.

Then, the image obtained by the output color conversion is subjected to a first sharpening according to the output image having the lowest resolution to thereby obtain the intermediate image. The first sharpening may be performed according to the output image whose noise is the most readily noticeable.

As mentioned above, the digitized image has a lower resolution than the print image in this embodiment (resolution A<resolution B), so the first sharpening (enhancement factor A) is performed according to the digitized image to produce the intermediate image.

Therefore, the intermediate image in the illustrate case includes both the regions of the digitized image and the print image, has the same resolution and color space as those of the print image and has undergone the first sharpening according to the digitized image.

The first sharpening is thus performed according to the output image whose resolution is the lowest or whose noise is the most readily noticeable, in other words, according to the output image which is most likely to be affected by the image quality deterioration due to noise to thereby produce the intermediate image such that each output image resulting from the intermediate image has no image quality deterioration due to noise but is high in image quality.

Once the intermediate image is produced in this way, the intermediate image is used to produce each output image, in other words, the digitized image and the print image.

As mentioned above, the intermediate image has the minimum region including both the regions of the digitized image and the print image (i.e., regions A+B), has the same resolution (scaling factor B) and color space (color space B) as the print image and has undergone the first sharpening (enhancement factor A) according to the digitized image.

When the digitized image is produced from the intermediate image, the intermediate image is first cropped to obtain the region of the digitized image (i.e., region A). Cropping is not necessary in the case where the intermediate image has the same image region as that of the output image to be produced irrespective of whether the output image is the print image or the digitized image.

Then, a second scaling is performed to obtain an image having the resolution (size) of the digitized image. As mentioned above, the first scaling is previously performed in the illustrated embodiment according to the print image and the intermediate image has the same resolution as that of the print image. Therefore, the intermediate image is subjected to the second scaling by a scaling factor A/B so as to compensate for the difference caused by the first scaling thereby obtaining an image having the same resolution as that of the digitized image.

The intermediate image has undergone the first sharpening according to the digitized image. Therefore, further sharpening process is basically not necessary. However, the second scaling that was performed in the previous step reduced the image sharpness and hence a second sharpening for compensating for the reduced sharpness (scaling correction) is performed. In other words, the second sharpening returns the sharpness of the intermediate image that has reduced by the second scaling to its original state.

Since the intermediate image is an image having the color space of the print image, the intermediate image is further subjected to color conversion into the color space of the digitized image (for example s-RGB), that is, the color space B is converted to the color space A to produce the digitized image.

The thus produced digitized image is, for example, output to a recording device for recording image (image data) on a storage medium.

On the other hand, even when the print image is produced from the intermediate image, the intermediate image is first cropped in the same manner to obtain the region of the print image (i.e., region B).

As mentioned above, the intermediate image has the same resolution and color space as those of the print image, so further scaling and color conversion for producing the print image are not necessary. Therefore, once the intermediate image is cropped, a second sharpening is performed to produce the print image. In the illustrated embodiment, the intermediate image has undergone the first sharpening according to the digitized image as mentioned above, so the second sharpening (enhancement factor B/A) is performed so as to compensate for the difference caused by the first sharpening according to the digitized image, thereby obtaining the image having the sharpness appropriate to the print image. The print image is thus produced.

The thus produced print image is output to the above- mentioned digital photoprinter.

FIG. 2B shows another embodiment of the operation of the image producing apparatus 10.

The above-mentioned embodiment shown in FIG. 2A refers to the case where, when a print image and a digitized image are produced, the print image has a higher resolution and a larger color space than the digitized image. However, the embodiment shown in FIG. 2B refers to the case where, when a print image and a digitized image are produced as in above, the digitized image has a higher resolution (A>B), whereas the print image has a larger color space (A<B).

First, the scanner 12 is used to scan the minimum region of the image of one frame that covers all the regions to be reproduced in the digitized image and the print image (i.e., regions A+B) in the resolution corresponding to the digitized image having a higher resolution (i.e., resolution A).

As mentioned above, in the scanner 12, output signals from the CCD sensor 34 are amplified in the amplifier 36 and subjected to A/D conversion and logarithmic conversion in the signal processing section 38 before being supplied to the image processor as an input image.

When the input image is supplied, the input image is first subjected to a first scaling by a scaling factor A so that the resulting image can have the same resolution as the digitized image whose resolution is higher. In other words, the intermediate image in this embodiment has the resolution (size) of the digitized image.

The input image having undergone the first scaling is then subjected to input color conversion to obtain an image having a specified color space and setup is further performed.

Then, output color conversion is performed to obtain an image having the same color space as the print image whose color space is larger (color space B).

The image obtained by the output color conversion is further subjected to a first sharpening. In this embodiment, the digitized image has a higher resolution than the print image, but image noise is more readily noticeable in the monitor display of the digitized image than in the print image. Therefore, in this embodiment, the first sharpening (enhancement factor A) corresponding to the digitized image in which noise is more readily noticeable is performed to obtain an intermediate image. Therefore, the intermediate image has both the regions of the digitized image and the print image (i.e., regions A+B), has the same resolution (scaling factor A) as the digitized image and the same color space (color space B) as the print image and has undergone the first sharpening (enhancement factor A) according to the digitized image.

Once the intermediate image is produced in this way, the intermediate image is used to produce the digitized image and the print image.

When the digitized image is produced from the intermediate image, the intermediate image is first cropped to obtain the region of the digitized image (i.e., region A).

As mentioned above, the intermediate image has undergone the first sharpening according to the digitized image in the resolution of the digitized image. Therefore, when the digitized image is produced from the intermediate image, further scaling and sharpening are not necessary.

Therefore, after having been cropped, the intermediate image is subjected to color conversion into the color space of the digitized image (for example s-RGB), that is, the color space B is converted to the color space A to produce the digitized image.

On the other hand, even when the print image is produced from the intermediate image, the intermediate image is first cropped in the same manner to obtain the region of the print image (i.e., region B).

In this embodiment, the intermediate image is an image having the resolution corresponding to the digitized image, so a second scaling by a scaling factor B/A is performed so as to compensate for the difference in resolution caused by the first scaling, thereby obtaining the image having the resolution of the print image.

The intermediate image has undergone the first sharpening according to the digitized image, so a second sharpening is further performed. to obtain the sharpness appropriate to the print image thereby producing the print image. In this embodiment, the intermediate image is an image having the color space of the print image (i.e., color space B) and hence color conversion is not necessary.

This image has previously undergone the second scaling and its sharpness is reduced. Therefore, in this process, the intermediate image is subjected to the second sharpening including a sharpening process for compensating for the difference caused by the first sharpening that was performed according to the digitized image and another sharpening process for compensating for the reduced sharpness due to the second scaling (scaling correction+B/A). In other words, the second sharpening allows the resulting image to have the sharpness of the intermediate image with the sharpness appropriate to the print image.

As is clear from the above description, according to the present invention in which an intermediate image common to all output images is produced and used to produce the output images, the output images can be produced by one scanning operation (by obtaining one input image).

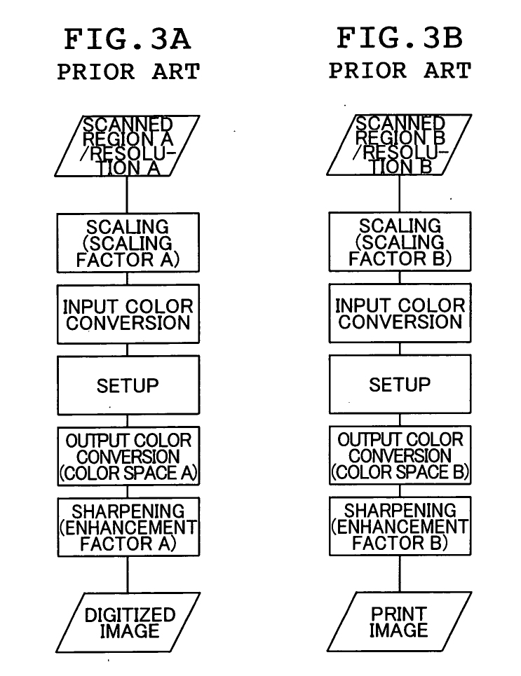

In a conventional method of producing output images, as shown in FIGS. 3A and 3B, input images obtained by scanning that was made for producing a digitized image (FIG. 3A) and a print image (FIG. 3B) need to be subjected to scaling, input color conversion, setup and various other processing, respectively, which results in redundant processing. In contrast, according to the present invention, processes common to the print image and the digitized image (two or more output images) to be produced, as exemplified by input color conversion and setup can be standardized, which enables the output images to be rapidly produced in a simplified manner while the number of processes is decreased.

In the embodiment shown in FIGS. 2A or 2B, the intermediate image has the same color space as the output image whose color space is the largest or the output image for which the highest image quality is required. However, this is not the sole case of the present invention but the intermediate image may be an image having a large color space encompassing color spaces of all output images. In other words, output color conversion may be performed so that the intermediate image can have such a color space.

This method requires one more color conversion process for obtaining the output images than in the embodiments shown in FIGS. 2A and 2B, but lack of information that may be caused during color conversion for obtaining output images in the case where the output images have considerably different color spaces or the number of output images is large can be prevented more advantageously to obtain the output images more consistently with high quality.

In the embodiments shown in FIGS. 2A and 2B, the output color conversion is performed to obtain the intermediate image. However, this is not the sole case of the present invention but the intermediate image may be produced without the output color conversion.

For example, when an image produced by the input color conversion has a large color space encompassing the color spaces of all output images, the image having the color space after the input color conversion may be used as the intermediate image without performing the output color conversion.

The embodiments described above refer to production of a digitized image and a print image from one original (one frame of the film F). However, the present invention is not particularly limited to this and may be applied to production of various types of images.

For example, production of print images appropriate to printers of different types and models as mentioned above, production of print images of different sizes to be supplied to a single destination or printer, production of digitized images appropriate to display units of different characteristics, production of digitized images of different color spaces such as s-RGB and Adobe-RGB, and production of output images including the above-mentioned two types of print images and/or two types of digitized images. In addition, the number of output images to be produced is of course not limited to two.

While the image producing method and apparatus of the present invention have been described above in detail with reference to the various embodiments, it should be noted that the invention is by no means limited to such embodiments but various improvements and modifications may of course be made without departing from the scope and spirit of the invention.

What is claimed is:

1. An image producing method for producing different output images from an input image having been obtained, comprising the steps of:
obtaining said input image that has a region covering all of said different output images and has a resolution corresponding to one output image of said different output images whose resolution is highest;
subjecting said obtained input image to at least one color conversion process, or a first scaling in accordance with said one output image whose resolution is highest and said at least one color conversion process to produce an intermediate image; and
subjecting said intermediate image to at least one of cropping appropriate to each output image, a second scaling based on a difference in resolution between said intermediate image and each output image, and color conversion into a color space of each output image to thereby produce said different output images.

2. The image producing method according to claim 1, wherein said input image is obtained by photoelectrically reading an original.

3. The image producing method according to claim 2, wherein a minimum region of said original covering all of said different output images is photoelectrically read in a resolution of said one output images whose resolution is highest.

4. The image producing method according to claim 1, wherein said intermediate image is an image whose color space is identical to that of a first output image whose color space is largest or for which highest image quality is required.

5. The image producing method according to claim 1, wherein said input image is converted to a first image having a specified color space, said first image is then subjected to image processing that has no input-output dependence to obtain a second image, and said second image obtained by said image processing is used to produce said intermediate image.

6. The image producing method according to claim 1, wherein said intermediate image is an image obtained by performing a first sharpening in accordance with a second output image whose noise is most readily noticeable.

7. The image producing method according to claim 6, wherein, when a third output image that does not conform to said first sharpening said intermediate image has undergone is to be produced, a second sharpening is performed in accordance with said third output image when said third output image is produced from said intermediate image.

8. The image producing method according to claim 1, wherein, when said second scaling is performed on said intermediate image to produce a fourth output image, said second scaling is followed by said second sharpening for compensating for degradation in image sharpness caused by said second scaling.

9. The image producing method according to claim 8, wherein, when said intermediate image is an image obtained by performing said first sharpening in accordance with said second output image whose noise is most readily noticeable, said second sharpening for compensating for said degradation in said image sharpness caused by said second scaling and a third sharpening corresponding to one of other output images than said second output image are performed in combination to thereby produce said one of said other output images.

10. An image producing apparatus, comprising:
a scanner for photoelectrically reading an image from an original; and
an image processor for processing said image read with said scanner to obtain different output images,
wherein, when said different output images are produced, said scanner reads a region of said original covering all of said different output images in a resolution corresponding to one output image of said different output images whose resolution is highest, and
wherein said image processor subjects said image read with said scanner to at least one color conversion process, or a first scaling in accordance with said one output image whose resolution is highest and said at least one color conversion process to produce an intermediate image, which is then subjected to at least one of cropping appropriate to an output region of each output image, a second scaling based on a difference in resolution between said intermediate image and each output image, and color conversion into a color space of each output image to thereby produce said different output images.
